(19) United States
(12) Patent Application Publication
(10) Pub. No.: US 2009/0187388 A1
(43) Pub. Date: Jul. 23, 2009

(54) METHOD AND SYSTEM FOR LOCATING LANDMARKS ON 3D MODELS

(75) Inventors: Chang Shu, Ottawa (CA); Zouhour Ben Azouz, Ottawa (CA)

Correspondence Address: Workman Nydegger;1000 Eagle Gate Tower, 60 East South Temple, Salt Lake City, UT, 84111, US

(73) Assignee: NATIONAL RESEARCH COUNCIL OF CANADA, Ottawa, ON (CA)

(21) Appl. No.: 12/280,973

(22) PCT Filed: Feb. 27, 2007
(86) PCT No.: PCT/CA07/00304

§ 371 Date: Dec. 8, 2008

Related U.S. Application Data
(60) Provisional application No. 60/776,945, filed on Feb. 28, 2006.

(51) Int. Cl. G06F 17/10

(52) U.S. Cl. 703/2

(57) ABSTRACT

A plurality of landmarks are automatically located on a 3-dimensional polygonal mesh of connected vertices. A probabilistic graph is generated for the plurality of landmarks pre-identified on each of a first set of 3-dimensional models. The graph represents local surface characteristics for each landmark and relational positions between neighboring pairs of landmarks. Local surface characteristics are determined for each vertex of the mesh. For each landmark, a set of the vertices is identified that satisfies a criteria based on a surface difference between the vertex local surface characteristics and the landmark local surface characteristics. A relational position for each pair of vertices from the sets of vertices corresponding to the neighboring pairs is determined based on the graph. One of the vertices is determined for each of the plurality of landmarks to minimize the surface difference and the relational difference for the landmark.

### BACKGROUND ART

3-dimensional (3D) imaging and measuring devices capture information from the surface of an object in order to create a 3D representation or model of the object. These 3D models enable different objects to be objectively measured, compared, recognized and quantitatively described. However, such objective comparison between models of different objects can be difficult since correspondence between various 3D models for objects in a same category of shapes is not easily determined. Examples of these categories include human faces and bodies, animals of the same family, etc. Although the exact shape of objects from the same category will vary, there is a common structure shared among all of these objects.

In reality, processing and comparing the 3D models produced by the imaging devices is complicated due to the large amount of data provided by the 3D models, which are often in the form of a mesh with a large number of points on the surface of the model that are connected together. A correspondence of points on the 3D models for different objects must be determined to provide a proper comparison of the different 3D models.

For 3D models of humans, the CAESAR (Civilian American and European Surface Anthropometry Resource) database (described in K. Robinette, H. Daanen, and E. Paquet; “The Caesar Project: A 3-D Surface Anthropometry Survey,” Second International Conference on 3-D Digital Imaging and Modeling (3DIM'99), p. 380-386, Ottawa, Canada, October 1999) provides 3D models of humans that have traditional anthropometric landmarks identified on the human bodies prior to scanning. Thus, when the 3D model is created from a scan of the human body, markers identifying specific anatomical landmarks are already present and can be used for correspondence of different 3D models to enable comparative quantitative descriptions of these models. However, markers are placed on the anatomical landmarks on the human body by an anthropometrist prior to scanning; a tedious process requiring about 30 minutes for each human body.

Many of the previous attempts to provide a computer system for comparing 3D models have required placement of markers by hand onto the object prior to scanning. Efforts made to automate the identification of landmarks on 3D models have produced results that are highly inaccurate.

### DISCLOSURE OF THE INVENTION

In accordance with one aspect there is provided a method of locating a plurality of landmarks on a 3-dimensional polygonal mesh of connected vertices, the method comprising: (i) generating a probabilistic graph for the plurality of landmarks that are pre-identified on each of a first set of 3-dimensional models, the probabilistic graph representing local surface characteristics for each of the plurality of landmarks and relational positions between neighboring pairs of the plurality of landmarks; (ii) determining local surface characteristics for each vertex of the mesh; (iii) identifying, for each of the plurality of landmarks, a set of the vertices satisfying a criteria based on a surface difference between the vertex local surface characteristics and the landmark local surface characteristics; (iv) determining a relational position for each pair of vertices from the sets of vertices corresponding to neighboring pairs from the plurality of landmarks based on the probabilistic graph; (v) determining a relational difference between the relational position of neighboring pairs and the relational position of the corresponding pairs of vertices; and (vi) determining one of the vertices for each of the plurality of landmarks that minimizes the surface difference and the relational difference for the landmark.

In accordance with one aspect there is provided a method of locating a plurality of landmarks on a 3-dimensional polygonal mesh of connected vertices, the method comprising: (i) developing a statistical model of local surface characteristics for each of the plurality of landmarks that are pre-identified on each of a first set of 3-dimensional models and the relational position of each pair of neighboring landmarks from the plurality of landmarks on each of the first set of 3-dimensional models; (ii) determining local surface characteristics for each vertex of the mesh; (iii) applying the local surface characteristics of each of the plurality of landmarks to each vertex of the mesh to determine a surface potential for each landmark to be attributed to each vertex; (iv) applying the relational position of each pair of neighboring landmarks to each pair of vertices to determine a compatibility potential representing position constraints for the pairs of neighboring landmarks based on the statistical model; (v) negotiating between the landmarks for an assignment of vertices to landmarks to optimize the surface potential and the compatibility potential for each landmark; and (vi) marking vertices assigned to landmarks as a corresponding landmark.

In accordance with one aspect there is provided a method of locating a plurality of landmarks on a 3-dimensional polygonal mesh of connected vertices, the method comprising: determining a spin image for each of the plurality of landmarks that are pre-identified on each of a first set of 3-dimensional models; determining a 3-dimensional translation for each pair of neighboring landmarks from the plurality of landmarks on each of the first set of 3-dimensional models; developing a statistical model of the spin images from all of the first set of 3-dimensional models for each of the plurality of landmarks and the 3-dimensional translation from all of the first set of 3-dimensional models for each pair of neighboring landmarks; determining a spin image for each vertex of the mesh; determining a surface potential for each of the plurality of landmarks to be attributed to a vertex of the mesh based on the statistical model and the spin images for the vertices; identifying, for each of the plurality of landmarks, a set of the vertices having the highest surface potential; determining a 3-dimensional translation for each pair of vertices from two of the sets corresponding to a pair of neighboring landmarks; determining a 3-dimensional translation potential for each pair of neighboring landmarks to be one of the pairs of vertices based on the statistical model and the 3-dimensional translations for each pair of vertices; performing probabilistic inferencing to maximize the surface potential and the 3-dimensional translation potential for each of the plurality of landmarks, wherein the vertex with the highest surface potential and the highest 3-dimensional translation potential for a landmark is assigned that landmark for the mesh.

In accordance with one aspect there is provided an article of manufacture comprising: a computer usable medium having computer readable program code means embodied therein for causing location of a plurality of landmarks on a 3-dimensional polygonal mesh of connected vertices, the computer readable program code means in said article of manufacture comprising: (i) computer readable program code means for causing a computer to generate a probabilistic graph for the plurality of landmarks that are pre-identified on each of a first set of 3-dimensional models, the probabilistic graph representing local surface characteristics for each of the plurality of landmarks and relational positions between neighboring pairs of the plurality of landmarks; (ii) computer readable program code means for causing a computer to determine local surface characteristics for each vertex of the mesh; (iii) computer readable program code means for causing a computer to identify, for each of the plurality of landmarks, a set of the vertices satisfying a criteria based on a surface difference between the vertex local surface characteristics and the landmark local surface characteristics; (iv) computer readable program code means for causing a computer to determine a relational position for each pair of vertices from the sets of vertices corresponding to neighboring pairs from the plurality of landmarks based on the probabilistic graph; (v) computer readable program code means for causing a computer to determine a relational difference between the relational position of neighboring pairs and the relational position of the corresponding pairs of vertices; and (vi) computer readable program code means for causing a computer to determine on of the vertices for each of the plurality of landmarks that minimizes the surface difference and the relational difference for the landmark.

In accordance with one aspect there is provided an article of manufacture comprising: a computer usable medium having computer readable program code means embodied therein for causing location of a plurality of landmarks on a 3-dimensional polygonal mesh of connected vertices, the computer readable program code means in said article of manufacture comprising: (i) computer readable program code means for causing a computer to develop a statistical model of local surface characteristics for each of the plurality of landmarks that are pre-identified on each of a first set of 3-dimensional models and the relational position of each pair of neighboring landmarks from the plurality of landmarks on each of the first set of 3-dimensional models; (ii) computer readable program code means for causing a computer to determine local surface characteristics for each vertex of the mesh; (iii) computer readable program code means for causing a computer to apply the local surface characteristics of each of the plurality of landmarks to each vertex of the mesh to determine a surface potential for each landmark to be attributed to each vertex; (iv) computer readable program code means for causing a computer to apply the relational position of each pair of neighboring landmarks to each pair of vertices to determine a compatibility potential representing position constraints for the pairs of neighboring landmarks based on the statistical model; (v) computer readable program code means for causing a computer to negotiate between the landmarks for an assignment of vertices to landmarks to optimize the surface potential and the compatibility potential for each landmark; and (vi) computer readable program code means for causing a computer to mark vertices assigned to landmarks as a corresponding landmark

In accordance with one aspect there is provided an article of manufacture comprising: a computer usable medium having computer readable program code means embodied therein for causing location of a plurality of landmarks on a 3-dimensional polygonal mesh of connected vertices, the computer readable program code means in said article of manufacture comprising: computer readable program code means for causing a computer to determine a spin image for each of the plurality of landmarks that are pre-identified on each of a first set of 3-dimensional models; computer readable program code means for causing a computer to determine a 3-dimensional translation for each pair of neighboring landmarks from the plurality of landmarks on each of the first set of 3-dimensional models; computer readable program code means for causing a computer to develop a statistical model of the spin images from all of the first set of 3-dimensional models for each of the plurality of landmarks and the 3-dimensional translation from all of the first set of 3-dimensional models for each pair of neighboring landmarks; computer readable program code means for causing a computer to determine a spin image for each vertex of the mesh;

computer readable program code means for causing a computer to determine a surface potential for each of the plurality of landmarks to be attributed to a vertex of the mesh based on the statistical and the spin images for the vertices; computer readable program code means for causing a computer to identify, for each of the plurality of landmarks, a set of the vertices having the highest surface potential; computer readable program code means for causing a computer to determine a 3-dimensional translation for each pair of vertices from two of the sets corresponding to a pair of neighboring landmarks; computer readable program code means for causing a computer to determine a 3-dimensional translation potential for each pair of neighboring landmarks to be one of the pairs of vertices based on the statistical model and the 3-dimensional translations for each pair of vertices; computer readable program code means for causing a computer to perform probabilistic inferencing to maximize the surface potential and the 3-dimensional translation potential for each of the plurality of landmarks, wherein the vertex with the highest simplified surface potential and the highest 3-dimensional translation potential for a landmark is assigned to that landmark for the mesh.

In accordance with one aspect there is provided a computer program product comprising: a memory having computer readable code embodied therein for execution by a processor, for locating a plurality of landmarks on a 3-dimensional polygonal mesh of connected vertices enabling of communication between a service provider and a plurality of devices on a peer-to-peer network, the code comprising: (i) code means for generating a probabilistic graph for the plurality of landmarks that are pre-identified on each of a first set of 3-dimensional models, the probabilistic graph representing local surface characteristics for each of the plurality of landmarks and relational positions between neighboring pairs of the plurality of landmarks; (ii) code means for determining local surface characteristics for each vertex of the mesh; (iii) code means for computer identifying, for each of the plurality of landmarks, a set of the vertices satisfying a criteria based on a surface difference between the vertex local surface characteristics and the landmark local surface characteristics; (iv) code means for determining a relational position for each pair of vertices from the sets of vertices corresponding to neighboring pairs from the plurality of landmarks based on the probabilistic graph; (v) code means for determining a relational difference between the relational position of neighboring pairs and the relational position of the corresponding pairs of vertices; and (vi) code means for determining one of the vertices for each of the plurality of landmarks that minimizes the surface difference and the relational difference for the landmark.

In accordance with one aspect there is provided a system for locating a plurality of landmarks on a 3-dimensional polygonal mesh of connected vertices comprising a local surface characteristics mechanism for determining local surface characteristics for each vertex of the mesh and for each of the plurality of landmarks that are pre-identified on each of a first set of 3-dimensional models; a graph mechanism for generating a probabilistic graph for the plurality of landmarks that are pre-identified on each of the first set of 3-dimensional models, the probabilistic graph representing local surface characteristics for each of the plurality of landmarks and relational positions between neighboring pairs of the plurality of landmarks; and a landmark mechanism for identifying, for each of the plurality of landmarks, a set of the vertices satisfying a criteria based on a surface difference between the vertex local surface characteristics and the landmark local surface characteristics, determining a relational position for each pair of vertices from the sets of vertices corresponding to neighboring pairs from the plurality of landmarks based on the probabilistic graph, determining a relational difference between the relational position of neighboring pairs and the relational position of the corresponding pairs of vertices; and determining one of the vertices for each of the plurality of landmarks that minimizes the surface difference and the relational difference for the landmark.

### BRIEF DESCRIPTION OF THE DRAWINGS

FIG. 1 is an exemplary computer system with which an embodiment of a system for locating landmarks in a 3D model may be associated;

FIG. 2 is an overview of a general flow for generating a probabilistic graph to describe a set of 3D models;

FIG. 3 is an overview of a general flow for locating landmarks in a 3D model using the probabilistic graph from FIG. 2;

FIGS. 4A and 4B are overviews of an exemplary implementation of the general flow of FIG. 2;

FIGS. 5A and 5B are overviews of an exemplary implementation of the general flow of FIG. 3; and

FIG. 6 is an overview of functional elements in a system for locating landmarks in a 3D model implementing the general flows of FIGS. 2 and 3.

### BEST MODE FOR CARRYING OUT THE INVENTION

The following detailed description of the embodiments does not limit the implementation of the embodiments to any particular computer programming language. The computer program product may be implemented in any computer programming language provided that the operating system provides the facilities that support the requirements of the computer program product. An embodiment may be implemented in the C or C++ computer programming language (or may be implemented in other computer programming languages in conjunction with C/C++) or any other such language. Any limitations presented would be a result of a particular type of operating system, computer programming language, or processing system and would not be a limitation of the embodiments described herein.

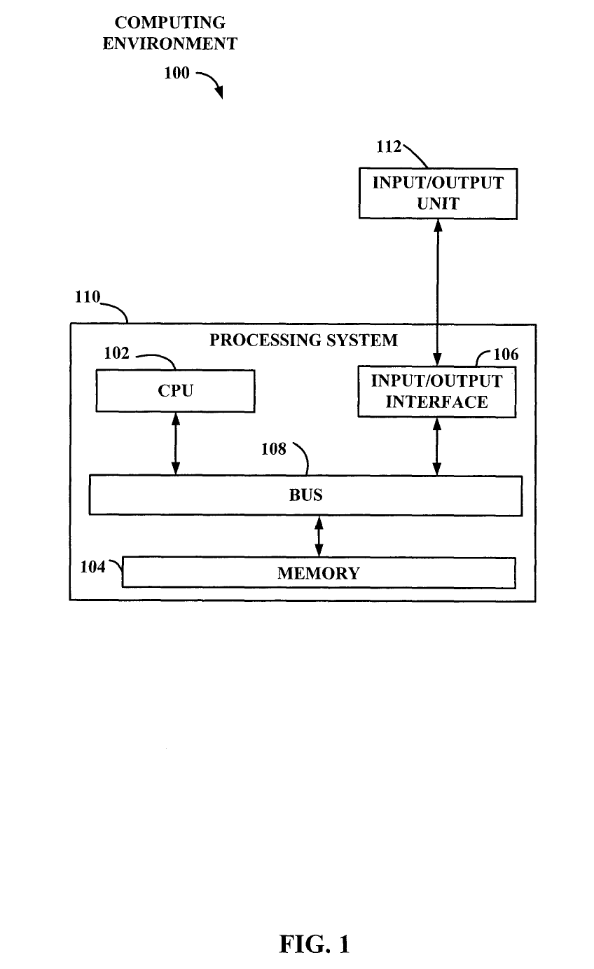

FIG. 1 illustrates a configuration of a computing environment 100 comprising a processing system 110 in which an embodiment of a system for locating landmarks in a 3D model may be implemented.

The processing system 110 includes a central processing unit (CPU) 102, a memory 104, an input/output interface 106 and a bus 108. The CPU 102, the memory 104 and the input/output interface 106 are connected with one another via the bus 108. The input/output interface 106 is configured so that it can be connected to an input/output unit 112 in the computing environment 100.

The CPU 102 can be a commercially available CPU or a customized CPU suitable for operations described herein. Other variations of the CPU 102 can include a plurality of CPUs interconnected to coordinate various operations and functions. The processing system 110 may serve as an apparatus for performing the present method through execution by the CPU 102.

Embodiments may be realized in a program stored in, for example, the memory 104. Alternatively, embodiments may be recorded on any type of recording medium such as a magnetic disk or an optical disk. Embodiments recorded on such a recording medium are loaded into the memory 104 of the processing system 110 via the input/output unit 112 (e.g. a disk drive).

One effective way to establish correspondences between 3D models of different shapes is to identify and match key points or landmarks present on every model. If enough landmarks are matched between two models then a point-to-point correspondence between the models can be made by interpolating points between the landmarks to provide for a more complete correspondence.

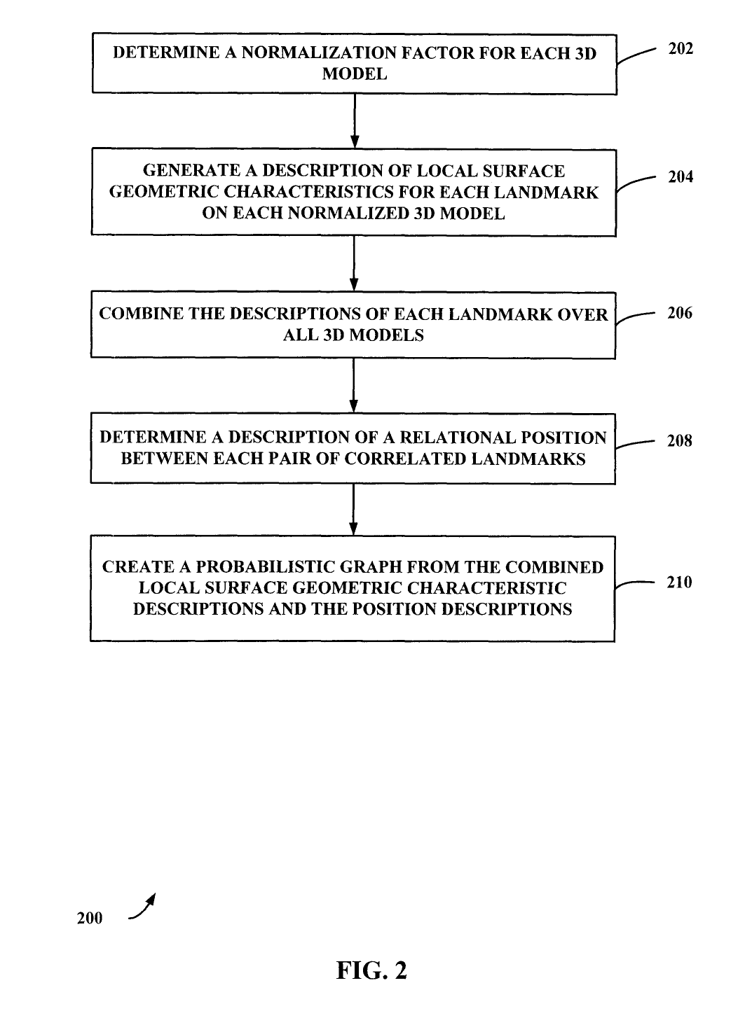

FIGS. 2 to 6 illustrate a method and system for automatically locating landmarks on a 3D model based on statistical learning. A first set of 3D models have the landmarks pre-marked on the objects prior to scanning. These landmarks have fixed definitions that rely on surface characteristics of the object and relative positions of other landmarks. The first set of 3D models is used to learn the definition of these landmarks (e.g. local surface geometric characteristics around the landmark and the relationships between positions of the landmarks). The probability of a point of the surface of a 3D model being a specific landmark is determined to depend on the local surface geometric characteristics as well as its relationships with other landmarks. These parameters affecting the landmark probabilities can be represented by a probabilistic graphical model, for example, an undirected probabilistic graphical model such as a Markov network or a directed probabilistic graphical model such as a Bayesian network (which will represent conditional dependencies between the positions of landmarks). The distributions of local surface geometric characteristics and distances between landmarks are incorporated into the probabilistic graph. By representing landmarks in the probabilistic graph, it is possible to model the correlation between the positions of different landmarks. When automatically locating landmarks on a 3D model that does not have pre-marked landmarks, the probability of each point being each landmark is evaluated by maximizing a joint probability defined in the probabilistic graph.

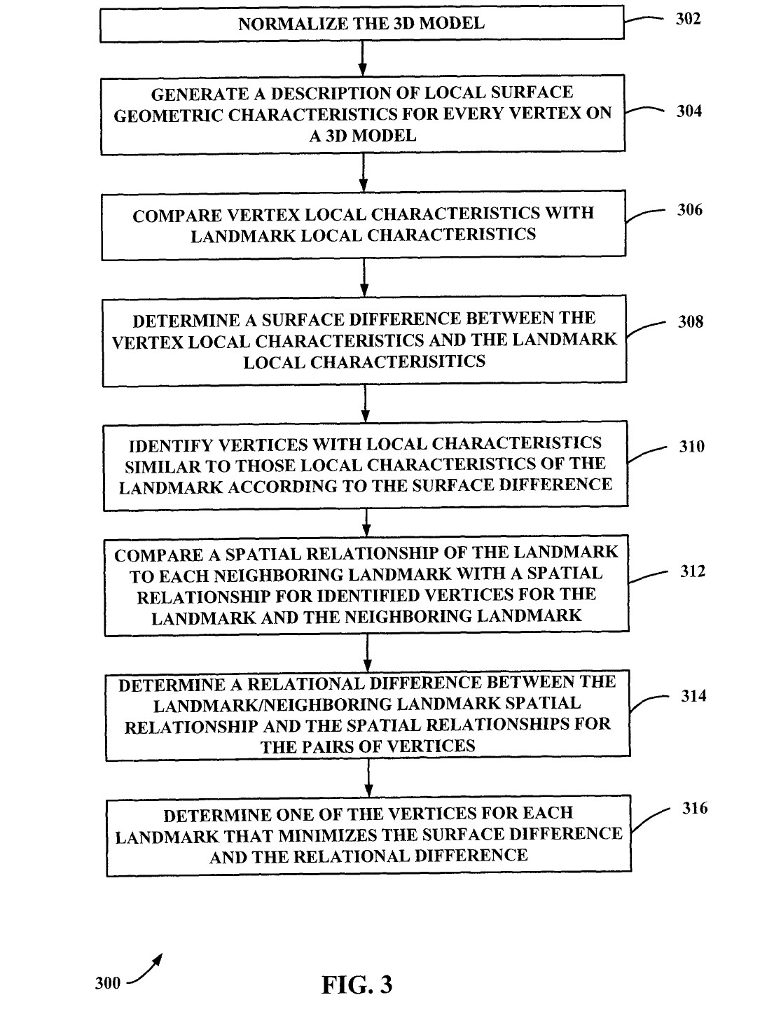

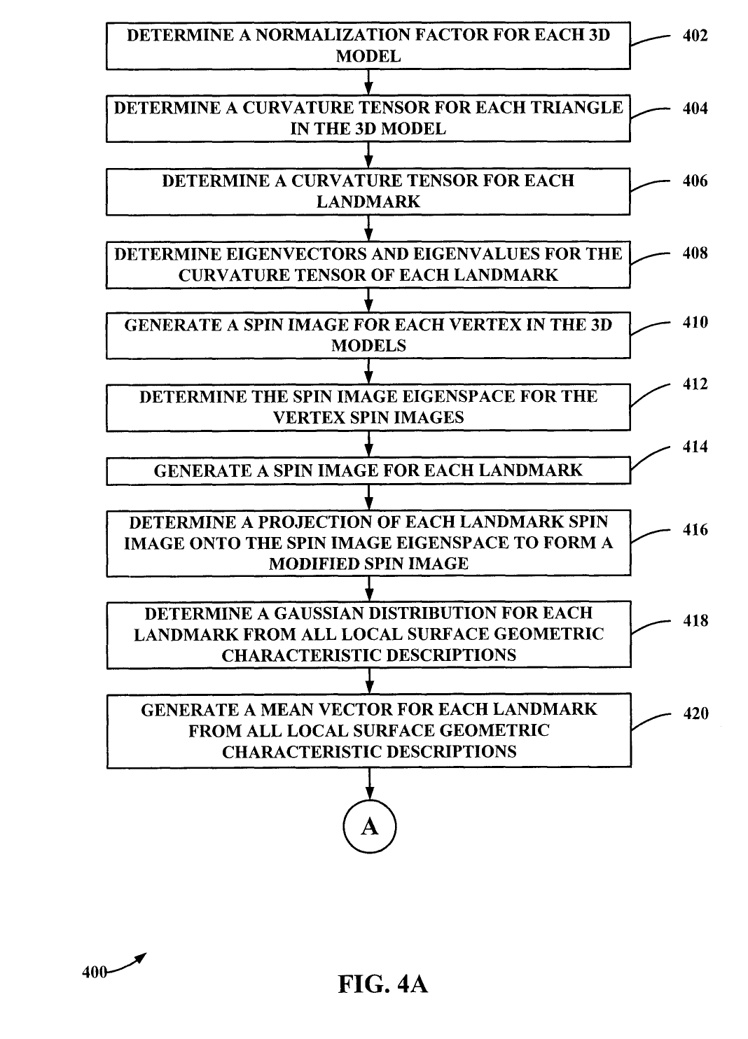

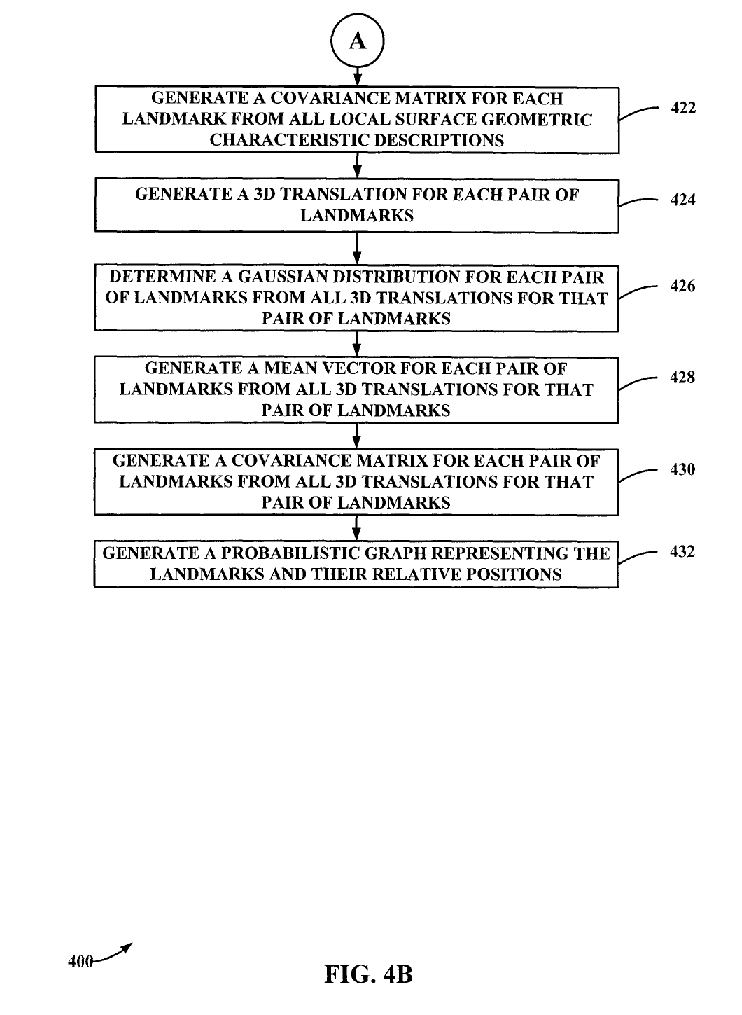

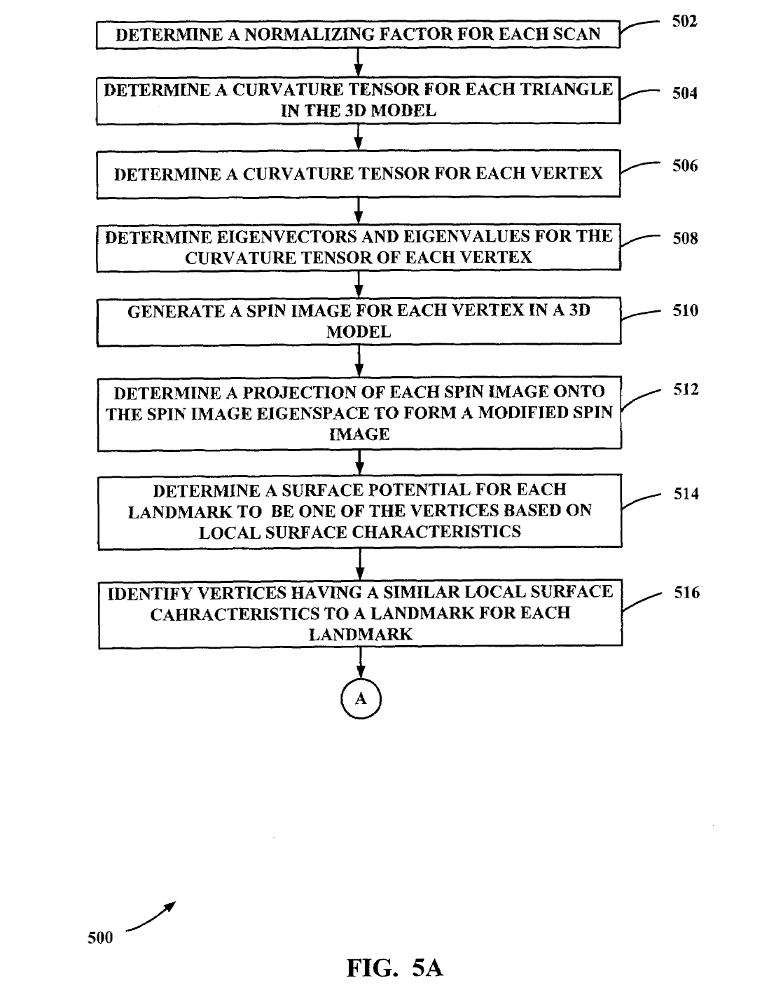

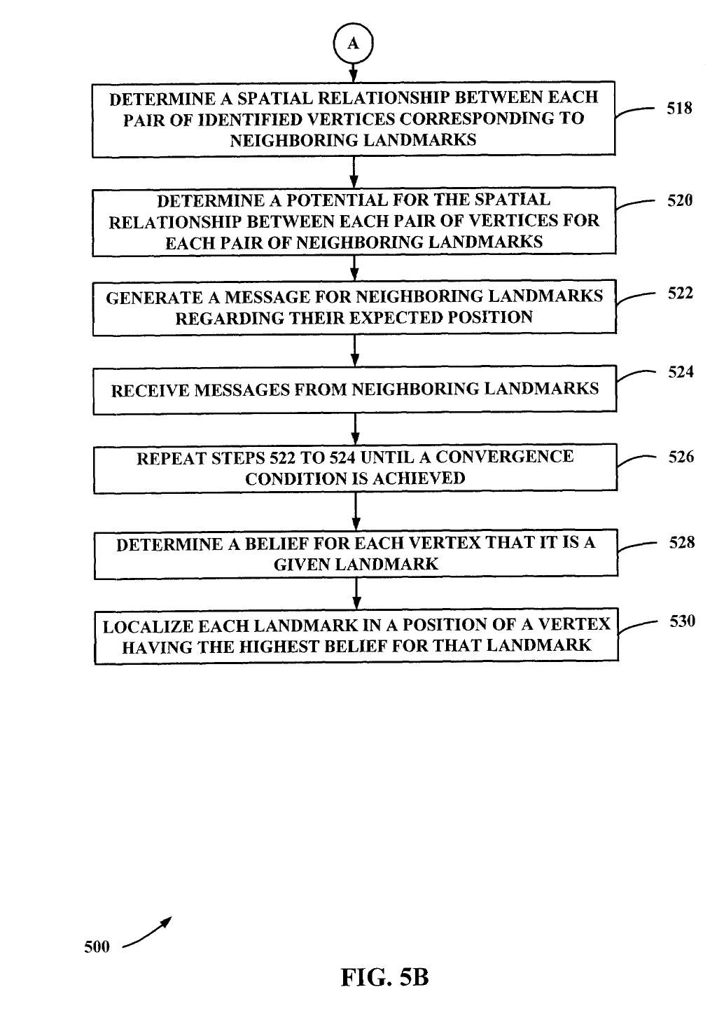

FIGS. 2 and 3 illustrate general flows for generating a probabilistic graph to describe a set of 3D models and locating landmarks on an unmarked 3D model using the probabilistic graph. FIGS. 4 and 5A and B illustrate exemplary implementations of the general flows in FIGS. 2 and 3.

FIG. 2 is an overview of a general flow 200 for generating a probabilistic graph to describe a set of 3D models. A 3D model is generally in the form of a surface mesh with vertices connected by edges representing points on the surface of an object. The surface shape of the 3D model is described by a dense collection of points, each with a surface normal. The surface normal for a vertex is perpendicular to the tangent plane at the vertex. The surface normal may be determined using the eigenvector having the smallest eigenvalue of the inertia matrix for the vertex and the other vertices directly connected to it. The points on the surface are such that a distance between the points can be determined.

Every 3D model in the set represents an object of the same family having the same basic structure. A set of landmarks is defined to enable comparison of each object. Each landmark is defined according to features of the object. Each landmark is located on each object and marked prior to scanning so that each of the 3D models also has an indication of the landmarks. From these pre-marked landmarks a probabilistic graph is generated to describe the characteristics of the 3D model in the local vicinity of each landmark and the position of a landmark relative to the position of the other landmarks. In this manner, a statistical description of the position of the landmarks is created (i.e. the probabilistic graph) that can be used to statistically determine the position of the same landmarks on another 3D model that does not have pre-marked landmarks, assuming that the unmarked object is of the same family as the marked object. Since the flow 200 describes the creation of the probabilistic graph, all 3D models in this flow 200 have pre-marked landmarks.

A normalization factor for each 3D model is determined and applied to the 3D model in step 202. The normalization factor takes into account the variance in the height and size of an object and scales the 3D model so that all 3D models have the same height and/or length. Since this is simply a scaling of the 3D model, the relative positions of the landmarks will not change but only be scaled by the same factor. By removing the variance in height and/or length, a proper comparison of the placement of the landmarks from one 3D model to another can be performed. The relative position between two landmarks is less variable if the 3D models are normalized. Also, after normalization a distribution for the position of each landmark can be generated.

The normalization factor is determined by scaling a dimension (e.g. height) such that the dimension of the 3D model when scaled by the normalization factor is the same for all models. For example, if Hₙₒᵣₘ is the new height for the model (i.e. the standardized height) and H_{orig} is the original height of the model then the normalization factor may be Hₙₒᵣₘ/H_{orig}. The normalization factor will be different for every model based on the size of the chosen dimension (H_{orig}).

A description of local surface geometric characteristics is generated in step 204 for each landmark on each normalized 3D model. The description may take into account various properties of the surface of the 3D model in the vicinity of each landmark, such as curvature, etc. Other characteristics may include 3D shape context and harmonic shape context as taught in “Recognizing Object in Range Data Using Regional Point Descriptors”; A. Frome, D. Huber, R. Kolluri, T. Bulow and J. Malik; Proceedings of the European Conference on Computer Vision (ECCV), May 2004. The size of the area around each landmark that is considered may be determined according to the expected change in surface characteristics. For example, if it is expected that the surface characteristics will change significantly in a small area then the area may either be increased to smooth out any such variations or it may be decreased to capture these variations.

A description of the local surface geometric characteristics for each landmark on each model is generated. All of the descriptions from all of the 3D models for each landmark are combined in step 206 to form a single description for each of the landmarks.

A description of a relational position between each pair of correlated landmarks is determined in step 208.

Using the combined descriptions for each landmark and the relational position description for each pair of landmarks, a probabilistic graph is created in step 210. In the probabilistic graph each node corresponds with a landmark and its position with edges connecting the nodes representing correlations between positions of neighboring landmarks. The probabilistic graph is a model of the joint probability distribution of the landmark positions.

FIG. 3 is an overview of a general flow 300 for locating landmarks in a 3D model that does not have pre-marked landmarks using the probabilistic graph generated in the flow 200 of FIG. 2. The flow 300 uses probabilistic inference over the probabilistic graph to locate the landmarks on the 3D models in such a manner so as to maximize a joint probability of the probabilistic graph. The 3D model used in FIG. 3 is in the form of a mesh scan with vertices connected by edges representing the surface of an object. Since the flow 300 describes the use of the probabilistic graph, all 3D models in this flow 300 do not have pre-marked landmarks.

A normalization factor is determined for and applied to the 3D model in step 302. This normalization factor is based on the assumption that the 3D model has the same underlying stricture as the set of 3D models used to create the probabilistic graph and is just a scaled version of this structure. The normalization factor determines the scaling factor and removes it from the 3D model so that the 3D model is on the same scale as the composite of 3D models represented by the probabilistic graph.

A description of local surface geometric characteristics is generated in step 304 for each vertex on the 3D model. As with the local surface geometric characteristic descriptions generated for each landmark in step 204 for the pre-marked 3D models, the description for each vertex of the 3D model may take into account various properties of the surface of the 3D model in the vicinity of the vertex, such as curvature, etc. The size of the area around each vertex that is considered when determining the description should be the same size used in step 204 to generate the local surface geometric characteristic descriptions for the landmarks. The manner in which the local surface geometric characteristic description for each vertex is generated in step 304 should be the same, or substantially similar, to the process used to generate the local surface geometric characteristic descriptions for the landmarks in step 204.

The local surface geometric characteristic description for each vertex is compared with the combined local surface geometric description for each landmark indicated in the probabilistic graph in step 306. By generating the two sets of local surface geometric characteristic descriptions in a substantially similar manner, meaningful comparison of the two sets in step 306 is possible.

As a result of the comparison in step 306, a surface difference between the vertex local characteristics and the landmark local characteristics is determined in step 308. The surface difference can be considered to be another representation of a potential or probability that, given the local surface geometric characteristics for a landmark and a vertex, the landmark is located at the vertex. Such a probability contains an implied comparison of the local surface geometric characteristics for the landmark and the vertex.

Those vertices having local surface characteristics similar to the local surface geometric characteristics for each landmark are identified in step 310. A set of vertices is generated for each landmark of those vertices having the smallest surface difference. This set may be formed from a predefined number of vertices with the smallest surface difference, from all vertices having a surface difference for the landmarks within a predefined range, etc.

A spatial relationship between pairs of vertices is determined and then compared with the spatial relationship between landmarks and neighboring landmarks as codified in the probabilistic graph in step 312. The spatial relationship between every pair of vertices that includes one of the identified vertices from step 310 is determined. This spatial relationship is compared with the landmark/neighboring landmark spatial relationships for the landmark for which the vertex was identified in step 310. The spatial relationship is determined from identified vertices for one landmark and identified vertices for a neighboring landmark.

A relational difference between each of the spatial relationships of the landmark and neighboring landmarks and the previously determined spatial relationship of the pairs of vertices is determined in step 314. The relational difference can be considered to be another representation of a potential or probability that, given the spatial relationship for the landmark/neighboring landmarks and the spatial relationship for the vertex pairs, one of the vertices in the vertex pair is a neighboring landmark. There is an implied comparison in difference determination of the spatial relationships that determines a likelihood that a vertex is a neighboring landmark.

Assignment of each of the landmarks to a vertex is determined in step 316. A vertex for each landmark that minimizes the surface difference and the relational difference for all landmarks is determined in step 316. This might not necessarily mean that the vertex having the smallest surface difference and the smallest relational difference is assigned to a landmark. Rather, the surface difference and the relational difference for all landmarks are taken into consideration so that both differences for all landmarks are minimized. That is, a vertex on the 3D model is identified for each landmark that has the closest local surface geometric characteristics taking into account the relative positions of neighboring landmarks and the difference between the neighboring landmark local surface geometric characteristic descriptions and the neighboring vertex local surface geometric characteristic descriptions.

FIGS. 4A and 4B is an overview of a flow 400 for an exemplary implementation of the general flow 200 in FIG. 2. Once again, since the flow 400 describes the creation of the probabilistic graph all 3D models in this flow have pre-marked landmarks.

The pre-marked landmarks are located on the 3D models in step 402. A normalization factor for each 3D model is determined in step 402. The normalization factor takes into account the variance in the height and size of an object and scales the 3D model so that all 3D models have the same height and/or length. This is done prior to determining local surface geometric characteristic descriptions for each landmark so that all resulting descriptions have the same scale and the descriptions for the same landmark from different 3D models can be combined.

A description of local surface geometric characteristics is generated for each landmark on each 3D model in steps 406 to 414. The local surface geometric characteristics description may include a modified spin image and/or principal curvatures of the local surface in this exemplary implementation.

The size of the area surrounding the landmark that will be used for determining the local surface geometric characteristic description considered may be determined according to the expected change in surface characteristics. For example, if it is expected that the surface characteristics will change significantly in a small area then the area may either be increased to smooth out any such variations or it may be decreased to capture these variations. The size of the area for the local surface geometric characteristic description is consistent for all landmarks and for each characteristic that forms the local surface geometric characteristic description.

The principal curvature of the local surface estimates curvatures on irregular triangle meshes. The curvature may be used for all landmarks/vertices or only a subset of these points. For example, the principal curvature may be used for those landmarks/vertices for which the curvature is more descriptive than the spin image. The principal curvature is determined in steps 404 to 408. The method for determining the principal curvature is derived from “Estimating Curvatures and Their Derivatives on Triangle Meshes”; Szymon Rusinkiewicz; Symposium on 3D Data Processing, Visualization and Transmission, 2004.

A curvature tensor is determined in step 404 for each triangle in the local area surrounding each landmark. The curvature tensor is expressed into a coordinate system related to the triangle. From the curvature tensor for each triangle, a curvature tensor for each landmark is determined in step 406. The curvature tensor for each landmark is determined by taking a weighted sum of the curvature tensors for each triangle adjacent to the landmark. The principal curvatures and principal directions for each landmark are determined in step 408 as the eigenvectors and eigenvalues, respectively, of the curvature tensor for the landmark.

A spin image is a two-dimensional histogram computed at an oriented point (e.g. landmark) of a surface mesh (e.g. 3D model). The premise of a spin image is that using a single point basis constructed from an oriented point (i.e. 3D point and surface normal), the position of other points on the surface can be described by the radial distance to the surface normal line and the axial distance above the tangent plane of the single point. The accumulation of these parameters for many points on the surface can be presented as an image at each oriented point where dark areas in the image correspond to large numbers of neighboring vertices having the same, or very similar, axial and radial distance values. These spin images describe the relative position of points on a rigid object with respect to a particular point on the same object and as such are independent of rigid transformations applied to the object. Spin images are rotation and translation invariant but not scale invariant; although the spin images from scaled versions of the same surface will be the same up to the scale factor between the surfaces. Thus, spin images are not determined until the 3D models have been normalized to remove this scale factor. Alternatively, the scale factor may be removed after the spin image has been created.

The spin images for each vertex in all of the model or a reduced set of the 3D models is generated in step 410. The spin image is a 2D array that encodes the density of points in a spin image. The indices of the array are the radial distance from the surface normal line for the landmark to a vertex and the axial distance of the vertex above the tangent place for the landmark. The values in the array represent the density of points having the same, or similar, radial and axial distance values. Spin images and methods for generating them are described in greater detail in A. Johnson, Spin-Images: A Representation for 3-D Surface Matching, PhD thesis, Robotics Institute, Carnegie Mellon University, Pittsburgh, Pa., August 1997.

Since the spin image is a high dimensional descriptor that characterizes local surface geometry around a landmark, the dimensionality of the spin image is reduced in steps 412 to 416 to reduce complexity for future computational efficiency. The eigenspace from all spin images from step 410 is determined in step 412. All spin images from all 3D models (or the reduced set of 3D models) are used to form a single eigenspace that is used to modify every spin image for the landmarks for each 3D model. The eigenspace for each spin image consists of eigenvalues and eigenvectors and may be determined using Principal Component Analysis. The most significant of the eigenvectors are determined by taking the eigenvector having the highest corresponding eigenvalue. The most significant eigenvectors are used to form the spin image eigenspace.

The spin image for each of the landmarks is generated in step 414. Since the landmarks correspond with a vertex on the 3D model, the spin image for the vertex corresponding to the landmarks determined in step 410 may be used. A separate spin image for each landmark may also be generated. A modified spin image is formed in step 416 by taking a projection of the spin image onto the spin image eigenspace. The same spin image eigenspace is used for every landmark and for every 3D model.

The determination of a modified spin image is performed for each landmark on each 3D model. Since all 3D models were normalized in step 402 prior to determining the spin image, all modified spin images have the same scale factor. After step 416 there is a series of modified spin images for each landmark.

A potential φᵢ(lᵢ) is associated with each node i to represent the likelihood that a landmark lᵢ corresponds to a given vertex on a 3D model. Each edge {lᵢlⱼ} in the network has a compatibility potential Ψᵢⱼ(lᵢlⱼ) to constrain the positions of the landmarks with their spatial relationships. The joint probability for a landmark is given by:

$$p ( L ) = \frac{1}{Z} {\prod }_{i} {ϕ}_{i} ( {l}_{i} ) {\prod }_{i , j} {ψ}_{ij} ( {l}_{i} , {l}_{j} ) \qquad Equation ( 1 )$$

The potentials φᵢ(lᵢ) and Ψᵢⱼ(lᵢlⱼ) encode a preference of the local surface geometric characteristics and maintain the spatial relationship between landmark pairs and are non-negative functions.

The parameters of the potentials for the nodes and edges of the probabilistic graph are determined in steps 418 to 422. The potential associated with each node in the network is based on the distribution of the spin image (or other local surface characteristic) for the associated landmark, which may be modeled as a Gaussian distribution. The potential φᵢ that a landmark is located on a vertex vₖ is defined as:

φᵢ(lᵢ=vₖ)=N(S(vₖ),μᵢ,Σᵢ) Equation (2)

where N is a multivariate Gaussian distribution with a mean vector μᵢ and a covariance matrix Σ_{I}, and S(vₖ) is the modified spin image for vertex vₖ. The potential φᵢ may also include the principal curvature (not incorporated into Equation (2)) for those cases where the landmark is described by both the spin image and the principal curvature. If the landmark is only described by the principal curvature then the principal curvature would replace the spin image in Equation (2). Two separate Gaussian distributions may also be created to represent the spin image and the principal curvatures separately.

A Gaussian distribution for each landmark is determined in step 418 using the series of modified spin image and/or the principal curvature for the landmark. Steps 420 to 422 set out further steps used in the determination of the Gaussian distribution for each landmark. The mean vector for each landmark from all modified spin images and/or the principal curvatures for that landmark is determined in step 420. A covariance matrix for each landmark is generated in step 422 from all modified spin images and/or the principal curvatures for that landmark. The mean vector and the covariance matrix form part of the definition of the Gaussian distribution for the landmark.

The potential associated with an edge is also modeled by a statistical model, such as a Gaussian distribution. A local coordinate system may be defined on each landmark using the surface normal and the two main curvature directions to describe the relationship between two landmarks. This may be determined by known methods such as the one disclosed in “Estimating Curvatures and Their Derivatives on Triangle Meshes”; Szymon Rusinkiewicz; Symposium on 3D Data Processing, Visualization and Transmission, 2004.

The relationship between two landmarks may be determined by a 3D translation in step 424 that brings one landmark into another. A 3D translation is generated for each pair of landmarks for each of the 3D models creating a series of 3D translations for each pair of landmarks. The relationship between two landmarks lᵢ and lⱼ may be characterized by the position of landmark lⱼ relative to the landmark lᵢ, i.e., it is characterized by the vector (xⱼ-xᵢ, yⱼ-yᵢ, zⱼ-zᵢ), where (xⱼ, yⱼ, zⱼ) are the coordinates of the landmark lⱼ.

A Gaussian distribution is determined in step 426 for each pair of landmarks using the 3D translations determined in step 424. Steps 428 and 430 set out further steps used in the determination of the Gaussian distribution for each pair of landmarks. The mean vector for each pair of landmarks from all 3D translations for that pair of landmarks is determined in step 428. A covariance matrix for each pair of landmarks is generated in step 430 from the 3D translations for that pair of landmarks. The mean vector and the covariance matrix form part of the definition of the Gaussian distribution for the pair of landmarks.

A graph representing the probabilistic graph is generated in step 432 from the Gaussian distribution of the landmarks and the Gaussian distribution of the pairs of landmarks. The Gaussian distribution for each of the landmarks forms the nodes of the probabilistic graph while the Gaussian distribution for each pair of landmarks formed the edges of the probabilistic graph.

FIGS. 5A and 5B are an overview of a flow 500 of an exemplary implementation of the general flow 300 in FIG. 3. Once again, since the flow 500 describes the use of the probabilistic graph, all 3D models in this flow 500 do not have any pre-marked landmarks. The flow 500 generally implements probabilistic inference over a probabilistic graph to find an assignment of the landmarks to vertices in the 3D model that maximize the joint probability for the probabilistic graph as set out in equation (1). Since exact inference is computationally intensive, when the probabilistic graph has a large number of nodes (i.e. a large number of landmarks), such probabilistic inferencing may be approximated, for example, using loopy belief propagation, based on iteratively propagating messages between adjacent nodes.

A normalization factor for each 3D model is determined in step 502. The normalization factor takes into account the variance in the height and size of an object and scales the 3D model so that all 3D models have the same height and/or length. Normalization is done prior to determining local surface geometric characteristic descriptions for each vertex so that all resulting descriptions have the same scale and the descriptions for the vertices can be compared with the descriptions for the landmarks determined in the flow 400.

A description of local surface geometric characteristics is generated for each vertex on the 3D model in steps 504 to 512. The local surface geometric characteristics description may include a modified spin image and/or principal curvatures of the local surface. The size of the area surrounding the vertex that will be used for determining the local surface geometric characteristics description should be the same as the size used in generating the local surface geometric characteristics description for the 3D models use to create the probabilistic graph.

The principal curvature is determined in steps 504 to 508. A curvature tensor is determined in step 504 for each triangle in the local area surrounding each landmark. The curvature tensor is expressed into a coordinate system related to the triangle. From the curvature tensor for each triangle, a curvature tensor for each landmark is determined in step 506. The curvature tensor for each landmark is determined by taking a weighted sum of the curvature tensors for each triangle adjacent to the landmark. The principal curvatures and principal directions for each landmark are determined in step 508 as the eigenvectors and eigenvalues, respectively, of the curvature tensor for the landmark.

The modified spin image is determined in steps 510 to 512. The spin image for each vertex is generated in step 510. The spin image is a high dimensional descriptor that characterizes local surface geometry around a vertex, as such, the dimensionality of the spin image is reduced in step 512 to reduce complexity for future computational efficiency. A modified spin image is formed in step 512 by taking a projection of the spin image onto the spin image eigenspace determined in step 412 of the flow 400.

A potential for each vertex to be a particular landmark in the probabilistic graph is determined in step 514 based on the local surface characteristics such as the modified spin image and/or the principal curvature for the vertex. This potential is determined using the Gaussian distribution of the landmark local surface geometric characteristic descriptions determined in steps 418 to 422 of the flow 400. The spin image and/or the principal curvature for the vertex is used with the multivariate Gaussian distribution to determine φᵢ(lᵢ=vₖ) for vertex vₖ of the 3D model for landmark lᵢ. The set of potentials are determined for each landmark representing the probability that the landmark could be attributed to each of the vertices based on the spin images and/or principal curvatures.

Vertices having a local surface characteristic similar to the local surface characteristic of a landmark are identified in step 516. These local surface characteristics are the same ones considered in step 514. A set of vertices is identified for each landmark of those vertices having the smallest difference between the modified spin image for the vertices and the landmark. This set may be formed from a predefined number of vertices with the smallest difference, from all vertices having a difference for the landmark within a predefined range, etc.

A spatial relationship between each pair of identified vertices corresponding to neighboring landmarks is determined in step 518. A set of the vertices is created for each landmark in step 516. These sets of vertices are used in step 518. Each pair of neighboring landmarks is identified based on the edges of the probabilistic graph. A spatial relationship is determined for every pair of vertices from the two sets of vertices corresponding to the pair of neighboring landmarks, where each pair of vertices is formed from one vertex from one set and a second vertex from the other set. This forms a plurality of spatial relationship representations for each pair of neighboring landmarks. For example, for a pair of neighboring landmarks (lᵢ,lⱼ), the spatial relationship is determined for all pairs of vertices that include a vertex from the search space of landmark lᵢ and a vertex from the search space of landmark lⱼ

A potential for the spatial relationships of each pair of vertices from step 518 is determined in step 520. These potentials are determined using the Gaussian distribution of the landmark pairs determined in steps 426 to 430 of the flow 400 for all neighboring landmark pairs. The potential for relational positions is determined for each pair of vertices for which a spatial relationship was determined in step 518. The spatial relation potentials are determined using the spatial relationship form step 518 for identified vertices for one landmark (from step 516) and identified vertices for a neighboring landmark (from step 516).

Steps 522 to 526 use loopy belief propagation to send messages between neighboring landmarks indicating expected positions. A message is generated in step 522 to be sent from one landmark to neighboring landmarks regarding the expected position of the neighboring landmarks to indicate the probability that the landmark be attributed to a given vertex. This message incorporates the potentials φᵢ and Ψᵢⱼ determined in steps 514 and 520. The message takes the form:

$${m}_{ij} ( {l}_{j} ) = {\sum }_{{l}_{i}} {ϕ}_{i} ( {l}_{i} ) {ψ}_{ij} ( {l}_{i} , {l}_{j} ) {\prod }_{k ∈ N ( i ) / \{ j \}} {m}_{ki} ( {l}_{i} ) \qquad Equation ( 3 )$$

where mᵢⱼ is the message from landmark i to neighboring landmark j regarding the position landmark i expects landmark j to be in if landmark i is located at a given vertex in the mesh. The form of the message sent is a vector where each element of the vector represents the probability of the receiving neighboring landmark j being attributed to a given vertex.

The neighboring landmarks send similar messages that are received in step 524. Since the message includes messages that are received from other landmarks, the receipt of a message from another landmark changes the message that would be sent to other landmarks. Steps 522 to 524 are repeated in step 526 until a convergence condition is achieved. The convergence condition may be a fixed number of iterations. Alternatively, convergence to a maximized belief may be determined by determining an average message variation over all landmarks (nodes) and all vertices. Convergence is then reached when, for example, the variation is less than a predetermined threshold. The joint probability includes the local surface potential and the spatial relation potentials for all landmark assignments to vertices in the mesh.

Based on these received messages a belief that a vertex is a particular landmark is determined in step 528. This belief bᵢ may be determined by:

$${b}_{i} ( {l}_{i} ) = K {ϕ}_{i} ( {l}_{i} ) {\prod }_{j ∈ N ( i )} {m}_{ji} ( {l}_{i} ) \qquad Equation ( 4 )$$

A position for each landmark is determined in step 530. A landmark is attributed to the vertex having the highest belief as determined in step 528 for that landmark.

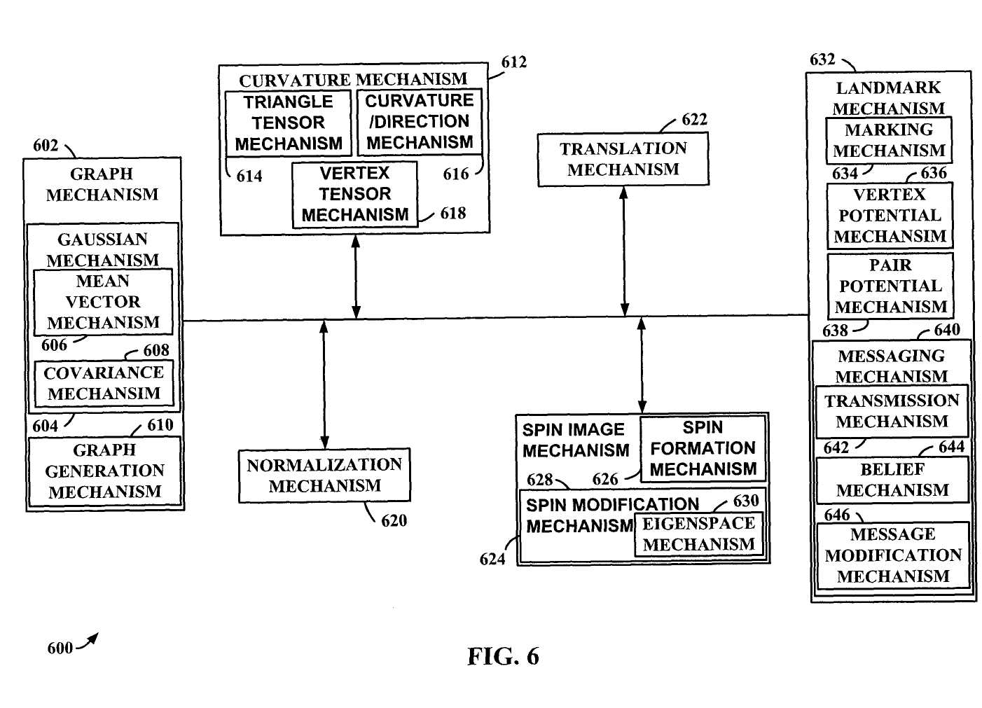

FIG. 6 is an overview 600 of functional elements in a system for locating landmarks in a 3D model implementing the general flows of FIGS. 2 and 3. The functional elements of the system include a graph mechanism 602, a curvature mechanism 612, a translation mechanism 622, a normalization mechanism 620, a spin image mechanism 624 and a landmark mechanism 632. The graph mechanism 602, in combination with the curvature mechanism 612, the translation mechanism 622, the normalization mechanism 620, and the spin image mechanism 624, are functions to create the probabilistic graph formed in flows 200 and 400. The landmark mechanism 632, in combination with the curvature mechanism 612, the translation mechanism 622, the normalization mechanism 620, and the spin image mechanism 624, use the probabilistic graph created by the graph mechanism 602 to identify landmarks on a 3D model that did not have pre-marked landmarks.

The normalization mechanism 620 determines a normalization factor for a 3D model. By applying a normalization factor to every 3D model, any variations in a particular dimension (e.g. height) and any scaling resulting from such variations may be removed before further processing is performed on a 3D model.

The spin image mechanism 624 generates a modified spin image for a particular point in a 3D model, such as a vertex or landmark. The spin image mechanism 624 includes a spin formation mechanism 626 and a spin modification mechanism 628, which includes an eigenspace mechanism 630. The spin formation mechanism 626 generates a standard spin image for a given landmark or vertex. Since the spin image is a high dimensional descriptor that characterizes local surface geometry around a landmark, the dimensionality of the spin image is reduced by the spin modification mechanism 628 to reduce complexity for future computational efficiency. The eigenspace mechanism 630 of the spin modification mechanism 628 determines the eigenspace (i.e. eigenvectors and eigenvalues) for the spin image of every vertex of a set of 3D models to form the spin image eigenspace. The most significant eigenvectors of the eigenspace composes the spin image eigenspace. A projection of a spin image onto the spin image eigenspace forms the modified spin image.

The curvature mechanism 612 generates the principal curvature for a particular point in a 3D model, such as a vertex or landmark. The curvature mechanism 612 includes a triangle tensor mechanism 614, a vertex tensor mechanism 618 and a curvature/direction mechanism 616. The triangle tensor mechanism 614 determines a curvature tensor for each triangle in a local area surrounding the point. The vertex tensor mechanism 618 determines a curvature tensor for each vertex using a weighted sum of the curvature tensors created by the triangle tensor mechanism 614 for each triangle adjacent to the vertex. The curvature/direction mechanism 616 determines the principal curvatures and principal directions for the vertex using the eigenvectors and eigenvalues, respectively, for the curvature tensor for the vertex.

The translation mechanism 622 determines a spatial relationship (e.g., a 3D translation) for each pair of vertices corresponding to a pair of neighboring landmarks and a spatial relationship between neighboring landmarks.

The graph mechanism 602 receives a series of 3D models having pre-marked landmarks in order to create the probabilistic graph representing the landmarks and their relative positions. The graph mechanism 602 includes a Gaussian mechanism 604 and a graph generation mechanism 610.

The graph mechanism 602 relies on the normalization mechanism 620, the spin image mechanism 624, the curvature mechanism 612 and the translation mechanism 622 to generate a quantitative description of the landmarks on each 3D model. The Gaussian mechanism 604 of the graph mechanism 602 generates a Gaussian distribution for the spin images and principal curvatures generated for each landmark to produce a Gaussian distribution for each landmark. The Gaussian mechanism 604 also generates a Gaussian distribution for the 3D translations of each pair of landmarks to describe the relative positions of the landmarks. Since a Gaussian distribution is determined by a mean vector and a covariance matrix, the Gaussian mechanism 604 includes a mean vector 606 for determining the mean vector and a covariance mechanism 608 for determining a covariance matrix.

The graph generation mechanism 610 brings the Gaussian descriptions for each landmark and the Gaussian descriptions for the relative positions of the landmarks together and creates a probabilistic graph representing all of the landmarks. This probabilistic graph is used by the landmark mechanism 632 for marking a 3D model that does not have landmarks already identified.

The landmark mechanism 632 includes a marking mechanism 634, a vertex potential mechanism 636, a pair potential mechanism 638 and a messaging mechanism 640. The landmark mechanism 632 also relies on the normalization mechanism 620, the spin image mechanism 624, the curvature mechanism 612, and the translation mechanism 622 to describe each vertex in a 3D model as well as the relationships between vertices.

The vertex potential mechanism 636 determines surface potentials for each landmark to be attributed to each vertex based on the landmark descriptions in the probabilistic graph. The vertex potential mechanism 636 may determine a set of vertices having the highest potential for each landmark and provide this to the pair potential mechanism 638. The pair potential mechanism 638 determines spatial relation potentials for a particular landmark based on relative positions of other vertices and landmarks based on the relative positions in the probabilistic graph. The pairs considered by the pair potential mechanism 638 may be those vertices identified by the vertex pair potential mechanism 636 for each landmark.

The messaging mechanism 640 includes a transmission mechanism 642, a belief mechanism 644 and a message modification mechanism 646. The messaging mechanism 640 uses loopy belief propagation to identify which vertices are landmarks using messaging between landmarks and the belief that neighboring landmarks be attributed to a particular vertex. The transmission mechanism 642 sends a message from a particular landmark to neighboring landmarks regarding what their relative positions and vertex assignments should be if the particular landmark is assumed to be attributed to a certain vertex. Each landmark receives messages from neighboring landmarks regarding this information. Since each message incorporates message received from other landmarks, each time a message is received the message is modified and sent out again. The belief mechanism 644 uses the received messages to determine a belief that a vertex is a certain landmark given the messages from neighboring landmarks. Both the transmission mechanism 642 and the belief mechanism 644 rely on the descriptions of the landmarks in the probabilistic graph.

Once all landmarks have been assigned to a vertex in the 3D model, based on the belief mechanism 644, the marking mechanism 634 marks these vertices as being particular landmarks.

In a specific exemplary implementation using 3D models of human bodies, the 3D models may be statistically analyzed to determine anthropometric information for numerous applications such as the design of various products including garments, automobiles, furniture, workstations and computer animation.

It is apparent to one skilled in the art that numerous modifications and departures from the specific embodiments described herein may be made without departing from the spirit and scope of the invention.

1. A method of locating a plurality of landmarks on a 3-dimensional polygonal mesh of connected vertices, the method comprising:
(i) generating a probabilistic graph for the plurality of landmarks that are pre-identified on each of a first set of 3-dimensional models, the probabilistic graph representing local surface characteristics for each of the plurality of landmarks and relational positions between for each pair of neighboring landmarks from the plurality of landmarks;
(ii) determining local surface characteristics for each vertex of the mesh;
(iii) applying the local surface characteristics of each of the plurality of landmarks to each vertex of the mesh to determine a surface potential for each landmark to be attributed to each vertex;
(iv) applying the relational position of each pair of neighboring landmarks to each pair of vertices to determine a compatibility potential representing position constraints for the pairs of neighboring landmarks based on the probabilistic graph;
(v) negotiating between the landmarks for an assignment of vertices to the plurality of landmarks to optimize the surface potential and the compatibility potential for each landmark; and
(vi) marking vertices assigned to landmarks as a corresponding landmark.

2. The method according to claim 1 wherein the 3-dimensional mesh and each of the first set of 3-dimensional models are of the same category and each of the plurality of landmarks are defined according to structural features of the 3-dimensional mesh and the first set of 3-dimensional models.

3. The method according to claim 1 wherein the step of generating a probabilistic graph comprising:
generating the local surface characteristics for each of the plurality of landmarks on each of the first set of 3-dimensional models;
combining the local surface characteristics for each of the plurality of landmarks from all of the first set of 3-dimensional models;
determining relational positions for all neighboring pairs from the plurality of landmarks on each of the first set of 3-dimensional models; and
combining the relational positions for each neighboring pair of landmarks from all of the first set of 3-dimensional models.

4. The method according to claim 3 wherein the wherein the step of generating a probabilistic graph further comprising:
creating the probabilistic graph using the combined local surface characteristics for each of the plurality of landmarks and the combined relational positions for each neighboring pair of landmarks.

5. The method according to claim 3 further comprising:
normalizing at least one dimension of each of the first set of 3-dimensional models and the 3-dimensional mesh prior to determining the local surface characteristics.

6. The method according to claim 69 wherein the criteria includes a predefined number of vertices having the smallest surface difference.

7. The method according to claim 69 wherein the criteria includes all vertices having a surface difference within a predefined range.

8. (canceled)

9. (canceled)

10. (canceled)

11. (canceled)

12. The method according to claim 3 wherein the step of combining the local surface characteristics comprising:
developing a statistical distribution to describe all of the local surface characteristics for each of the plurality of landmarks over all of the first set of 3-dimensional models, and wherein the step of combining the relational positions comprising:
developing a statistical distribution to describe all of the relational positions for each pair of neighboring landmarks over all of the first set of 3-dimensional models.

13. The method according to claim 12 wherein the step of developing a statistical distribution to describe the local surface characteristics comprising:
determining a Gaussian distribution to describe all of the local surface characteristics for each of the plurality of landmarks over all of the first set of 3-dimensional models, the step of determining comprising:
determining a mean vector of the local surface characteristics for each of the plurality of landmarks; and
determining a covariance matrix of the local surface characteristics for each of the plurality of landmarks;
and wherein the step of developing a statistical distribution to describe the relational positions comprising:
determining a Gaussian distribution to describe all of the relational positions for each pair of neighboring landmarks over all of the first set of 3-dimensional models, the step of determining comprising:
determining a mean vector of the relational positions for each pair of neighboring landmarks; and
determining a covariance matrix of the relational positions for each pair of neighboring landmarks.

14. (canceled)

15. The method according to claim 1 wherein the step of applying the local surface characteristics comprising:
determining a multivariate Gaussian distribution with the local surface characteristics of the vertex and the local surface characteristics model to represent the potential,
and wherein the step of applying the relational position comprising:
determining a multivariate Gaussian distribution with the relational position of the pair of neighboring vertices and the relational position model to represent the compatibility potential.

16. (canceled)

17. The method according to claim 1 wherein the local surface characteristics of the plurality of landmarks and the vertices of the mesh are at least one of a spin image, a modified spin image and a principal curvature.

18. The method according to claim 1 wherein the step of negotiating comprising:
selecting an assignment of vertices to the plurality of landmarks;
determining a joint probability for the plurality of landmarks based on the selected assignment and the surface potential and the compatibility potential for vertices in the selected assignment; and
repeating the step of determining a joint probability with a revised selected assignment to maximize the joint probability.

19. (canceled)

20. (canceled)

21. (canceled)

22. (canceled)

23. (canceled)

24. (canceled)

25. (canceled)

26. The method according to claim 1 wherein the local surface characteristics of the plurality of landmarks and the vertices of the mesh are spin images, the method further comprising:
simplifying a spin image for each of the plurality of landmarks comprising:
determining spin images for each vertex on a subset of the first set of 3-dimensional models;
determining an eigenspace including eigenvectors and eigenvalues for the spin images from the subset of 3-dimensional models;
determining a set of eigenvectors having the highest corresponding eigenvalue, the set of eigenvectors forming the spin image eigenspace; and
projecting the spin image for each of the plurality of landmarks onto the spin image eigenspace to form a modified spin image.

27. The method according to claim 26 further comprising:
simplifying a spin image for each vertex in the mesh comprising:
projecting the spin image onto the spin image eigenspace to form a modified spin image for each vertex in the mesh.

28. The method according to claim 71 wherein the step of performing probabilistic inferencing comprising:
performing loopy belief propagation to maximize the surface potential and the compatibility potential for each of the plurality of landmarks.

29. The method according to claim 28 wherein the step of performing loopy belief propagation comprising:
generating messages to be sent from each landmark to neighboring landmarks indicating an expected position based on the surface potential and the 3-dimensional translation potential;
repeatedly revising the messages based on message received from neighboring landmarks until a convergence condition is achieved;
determining a belief for each landmark that the landmark is assigned to each of the plurality of landmarks is attributed to each of the vertices based on messages from neighboring landmarks, the surface potential and the compatibility potential, wherein each landmark is attributed to the vertex having the highest belief for that landmark.

30. The method according to claim 29 wherein the convergence condition is one of repeating for a fixed number of iterations and a difference in the revised belief being below a threshold.

31. An article of manufacture comprising:
a computer usable medium having computer readable program code means embodied therein for causing location of a plurality of landmarks on a 3-dimensional polygonal mesh of connected vertices, the computer readable program code means in said article of manufacture comprising:
(i) computer readable program code means for causing a computer to generate a probabilistic graph for the plurality of landmarks that are pre-identified on each of a first set of 3-dimensional models, the probabilistic graph representing local surface characteristics for each of the plurality of landmarks and relational positions for each pair of neighboring landmarks from the plurality of landmarks;
(ii) computer readable program code means for causing a computer to determine local surface characteristics for each vertex of the mesh;
(iii) computer readable program code means for causing a computer to apply the local surface characteristics of each of the plurality of landmarks to each vertex of the mesh to determine a surface potential for each landmark to be attributed to each vertex;
(iv) computer readable program code means for causing a computer to apply the relational position of each pair of neighboring landmarks to each pair of vertices to determine a compatibility potential representing position constraints for the pairs of neighboring landmarks based on the probabilistic graph;
(v) computer readable program code means for causing a computer to negotiate between the landmarks for an assignment of vertices to the plurality of landmarks to optimize the surface potential and the compatibility potential for each landmark; and
(vi) computer readable program code means for causing a computer to mark vertices assigned to landmarks as a corresponding landmark.

32. The article of manufacture according to claim 31 wherein the computer readable program code means for causing a computer to generate a probabilistic graph comprising:
computer readable program code means for causing a computer to generate the local surface characteristics for each of the plurality of landmarks on each of the first set of 3-dimensional models;
computer readable program code means for causing a computer to combine the local surface characteristics for each of the plurality of landmarks from all of the first set of 3-dimensional models;
computer readable program code means for causing a computer to determine relational positions for all neighboring pairs from the plurality of landmarks on each of the first set of 3-dimensional models; and
computer readable program code means for causing a computer to combine the relational positions for each neighboring pair of landmarks from all of the first set of 3-dimensional models.

33. The article of manufacture according to claim 32 wherein the computer readable program code means for causing a computer to generate a probabilistic graph further comprising:
computer readable program code means for causing a computer to create the probabilistic graph using the combined local surface characteristics for each of the plurality of landmarks and the combined relational positions for each neighboring pair of landmarks.

34. The article of manufacture according to claim 31 further comprising:
computer readable program code means for causing a computer to normalize at least one dimension of each of the first set of 3-dimensional models and the 3-dimensional mesh prior to determining the local surface characteristics.

35. The article of manufacture according to claim 72 wherein the criteria includes a predefined number of vertices having the smallest surface difference.

36. The article of manufacture according to claim 72 wherein the criteria includes all vertices having a surface difference within a predefined range.

37. (canceled)

38. (canceled)

39. (canceled)

40. The article of manufacture according to claim 32 wherein the computer readable program code means for causing a computer to combine the local surface characteristics comprising:
computer readable program code means for causing a computer to develop a statistical distribution to describe all of the local surface characteristics for each of the plurality of landmarks over all of the first set of 3-dimensional models,
and wherein the computer readable program code means for causing a computer to combine the relational positions comprising:
computer readable program code means for causing a computer to develop a statistical distribution to describe all of the relational positions for each pair of neighboring landmarks over all of the first set of 3-dimensional models.

41. The article of manufacture according to claim 40 wherein the computer readable program code means for causing a computer to develop a statistical distribution to describe the local surface characteristics comprising:
computer readable program code means for causing a computer to determine a Gaussian distribution to describe all of the local surface characteristics for each of the plurality of landmarks over all of the first set of 3-dimensional models, the computer readable program code means for causing a computer to determine comprising:
computer readable program code means for causing a computer to determine a mean vector of the local surface characteristics for each of the plurality of landmarks; and
computer readable program code means for causing a computer to determine a covariance matrix of the local surface characteristics for each of the plurality of landmarks;
and wherein the computer readable program code means for causing a computer to develop a statistical distribution to describe the relational positions comprising:
computer readable program code means for causing a computer to determine a Gaussian distribution to describe all of the relational positions for each pair of neighboring landmarks over all of the first set of 3-dimensional models the computer readable program code means for causing a computer to determine comprising:
computer readable program code means for causing a computer to determine a mean vector of the relational positions for each pair of neighboring landmarks; and
computer readable program code means for causing a computer to determine a covariance matrix of the relational positions for each pair of neighboring landmarks.

42. (canceled)

43. The article of manufacture according to claim 41 wherein the computer readable program code means for causing a computer to apply the local surface characteristics comprising:
computer readable program code means for causing a computer to determine a multivariate Gaussian distribution with the local surface characteristics of the vertex and the local surface characteristics model to represent the potential,
and wherein the computer readable program code means for causing a computer to step apply the relational position comprising:
computer readable program code means for causing a computer to determine a multivariate Gaussian distribution with the relational position of the pair of neighboring vertices and the relational position model to represent the compatibility potential.

44. (canceled)

45. The article of manufacture according to claim 31 wherein the local surface characteristics of the plurality of landmarks and the vertices of the mesh are at least one of a spin image, a modified spin image and a principal curvature.

46. The article of manufacture according to claim 31 wherein the computer readable program code means for causing a computer to negotiate comprising:
computer readable program code means for causing a computer to select an assignment of vertices to the plurality of landmarks;
computer readable program code means for causing a computer to determine a joint probability for the plurality of landmarks based on the selected assignment and the surface potential and the compatibility potential for vertices in the selected assignment and repeatedly determine a joint probability with a revised selected assignment to maximize the joint probability.

47. (canceled)

48. (canceled)

49. (canceled)

50. (canceled)

51. (canceled)

52. (canceled)

53. The article of manufacture according to claim 31 wherein the local surface characteristics of the plurality of landmarks and the vertices of the mesh are spin images, the computer usable medium further comprising:
computer readable program code means for causing a computer to simplify a spin image for each of the plurality of landmarks comprising:
computer readable program code means for causing a computer to determine spin images for each vertex on a subset of the first set of 3-dimensional models;
computer readable program code means for causing a computer to determine an eigenspace including eigenvectors and eigenvalues for the spin images from the subset of 3-dimensional models;
computer readable program code means for causing a computer to determine a set of eigenvectors having the highest corresponding eigenvalue, the set of eigenvectors forming the spin image eigenspace; and
computer readable program code means for causing a computer to project the spin image for each of the plurality of landmarks onto the spin image eigenspace to form a modified spin image.

54. The article of manufacture according to claim 53 wherein the computer usable medium further comprising:
computer readable program code means for causing a computer to simplify a spin image for each vertex in the mesh comprising:
computer readable program code means for causing a computer to project the spin image onto the spin image eigenspace to form a modified spin image for each vertex in the mesh.

55. The article of manufacture according to claim 74 wherein the computer readable program code means for causing a computer to perform probabilistic inferencing comprising:
computer readable program code means for causing a computer to perform loopy belief propagation to maximize the surface potential and the compatibility potential for each of the plurality of landmarks.

56. The article of manufacture according to claim 55 wherein the computer readable program code means for causing a computer to perform loopy belief propagation comprising:
computer readable program code means for causing a computer to generate messages to be sent from each landmark to neighboring landmarks indicating an expected position based on the surface potential and the 3-dimensional translation potential;
computer readable program code means for causing a computer to repeatedly revise the messages based on message received from neighboring landmarks until a convergence condition is achieved;
computer readable program code means for causing a computer to determine a belief for each landmark that the landmark is assigned to each of the plurality of landmarks is attributed to each of the vertices based on messages from neighboring landmarks, the surface potential and the compatibility potential, wherein each landmark is attributed to the vertex having the highest belief for that landmark.

57. The article of manufacture according to claim 56 wherein the convergence condition is one of repeating for a fixed number of iterations and a difference in the revised belief being below a threshold.

58. A computer program product comprising:
a memory having computer readable code embodied therein for execution by a processor, for locating a plurality of landmarks on a 3-dimensional polygonal mesh of connected vertices enabling of communication between a service provider and a plurality of devices on a peer-to-peer network, the code comprising:
(i) code means for generating a probabilistic graph for the plurality of landmarks that are pre-identified on each of a first set of 3-dimensional models, the probabilistic graph representing local surface characteristics for each of the plurality of landmarks and relational positions for each pair of neighboring landmarks from the plurality of landmarks;
(ii) code means for determining local surface characteristics for each vertex of the mesh;
(iii) code means for computer applying the local surface characteristics of each of the plurality of landmarks to each vertex of the mesh to determine a surface potential for each landmark to be attributed to each vertex;
(iv) code means for applying the relational position of each pair of neighboring landmarks to each pair of vertices to determine a compatibility potential representing position constraints for the pairs of neighboring landmarks based on the probabilistic graph;
(v) code means for negotiating between the landmarks for an assignment of vertices to the plurality of landmarks to optimize the surface potential and the compatibility potential for each landmark; and
(vi) code means for marking vertices assigned to landmarks as a corresponding landmark.

59. A system for locating a plurality of landmarks on a 3-dimensional polygonal mesh of connected vertices comprising
a local surface characteristics mechanism for determining local surface characteristics for each vertex of the mesh and for each of the plurality of landmarks that are pre-identified on each of a first set of 3-dimensional models;
a graph mechanism for generating a probabilistic graph for the plurality of landmarks that are pre-identified on each of the first set of 3-dimensional models, the probabilistic graph representing local surface characteristics for each of the plurality of landmarks and relational positions between neighboring pairs of the plurality of landmarks; and
a landmark mechanism for identifying, for each of the plurality of landmarks, a set of the vertices satisfying a criteria based on a surface difference between the vertex local surface characteristics and the landmark local surface characteristics, determining a relational position for each pair of vertices from the sets of vertices corresponding to neighboring pairs from the plurality of landmarks based on the probabilistic graph, determining a relational difference between the relational position of neighboring pairs and the relational position of the corresponding pairs of vertices; and determining one of the vertices for each of the plurality of landmarks that minimizes the surface difference and the relational difference for the landmark.

60. The system according to claim 59 wherein the local surface characteristics mechanism comprises:
a spin image mechanism for determining a modified spin image for each of the plurality of landmarks and for each vertex of the mesh, wherein the local surface characteristics include the modified spin imag.

61. The system of claim according to claim 60 wherein the spin image mechanism comprising:
a spin formation mechanism for determining a spin image; and
a spin modification mechanism for modifying the spin image by determining a spin image eigenspace from an eigenspace of spin images for each vertex on a subset of the first set of 3-dimensional models using a set of eigenvectors having the highest corresponding eigenvalue and projecting the spin image onto the spin image eigenspace to form the modified spin image

62. The system according to claim 59 wherein the local surface characteristics mechanism comprising:
a curvature mechanism for determining a principal curvature for each of the plurality of landmarks and for each vertex of the mesh, wherein the local surface characteristics include the principal curvature.

63. The system according to claim 62 wherein the curvature mechanism comprising:
a triangle tensor mechanism for determining a curvature tensor for each triangle in the mesh and in a defined area around each of the plurality of landmarks;
a vertex tensor mechanism for determining a curvature tensor for each vertex in the mesh based on the curvature tensor for each triangle in a defined area around the vertex and for determining a curvature tensor for each of the plurality of landmarks based on the curvature tensor for each triangle in a defined area around the landmark; and
a curvature direction mechanism for determining the eigenvector of the vertex curvature tensor having the highest eigenvalue, the eigenvector being the principal curvature.

64. The system according to claim 59 wherein the graph mechanism comprising:
a Gaussian mechanism for determining a Gaussian distribution to describe all of the local surface characteristics for each of the plurality of landmarks over all of the first set of 3-dimensional models and for determining a Gaussian distribution to describe all of the relational positions for each pair of neighboring landmarks over all of the first set of 3-dimensional models.

65. The system according to claim 59 further comprising:
a normalization mechanism for normalizing at least one dimension of each of the first set of 3-dimensional models and the 3-dimensional mesh prior to determining the local surface characteristics.

66. The system according to claim 59 further comprising:
a translation mechanism for determining a 3-dimensional translation to represent the relational position between neighboring landmarks.

67. The system according to claim 59 wherein the landmark mechanism comprising:
a vertex potential mechanism for determining a surface potential for each of the plurality of landmarks to be attributed to a vertex of the mesh based on the probabilistic graph and the surface difference;
a pair potential mechanism for determining a 3-dimensional translation potential for each pair of neighboring landmarks to be vertices based on the probabilistic graph and the relational difference; and
a messaging mechanism for performing probabilistic inferencing to maximize the surface potential and the 3-dimensional translation potential for each of the plurality of landmarks, wherein the vertex with the highest surface potential and the highest 3-dimensional translation potential for a landmark is assigned to that landmark for the mesh.

68. The system according to claim 67 where the messaging mechanism comprising:
a transmission mechanism for generating messages to be sent from each landmark to neighboring landmarks indicating an expected position based on the surface potential and the 3-dimensional translation potential and repeatedly revising the messages based on messages received from neighboring landmarks until a convergence condition is achieved;
a belief mechanism for determining a belief for each landmark that the landmark is assigned to each of the plurality of landmarks is attributed to each of the vertices based on messages from neighboring landmarks, the surface potential and the 3-dimensional translation potential, wherein each landmark is attributed to the vertex having the highest belief for that landmark,
wherein the messaging mechanism performs probabilistic inferencing until a convergence condition is achieved, where the convergence condition is one of repeating for a fixed number of iterations and a difference in the revised belief being below a threshold.

69. The method according to claim 1 wherein the step of applying the local surface characteristics comprising:
identifying, for each of the plurality of landmarks, a set of the vertices satisfying a criteria based on a surface difference between the vertex local surface characteristics and the landmark local surface characteristics;
and wherein the compatibility potential is based on a relational difference between the relational position of the pairs of neighboring landmarks and the relational position of each pair of vertices from the set of vertices corresponding to the pairs of neighboring landmarks;
and wherein the step of negotiating comprising:
determining one of the vertices for each of the plurality of landmarks that minimizes the surface difference and the relational difference for the landmark.

70. The method according to claim 1 wherein the relational position is a 3-dimensional translation.

71. The method according to claim 1 wherein the step of negotiating comprising:
performing probabilistic inferencing to maximize the surface potential for each of the compatibility potential for each of the plurality of landmarks.

72. The article of manufacture according to claim 31 wherein the computer readable program code means for causing a computer to apply the local surface characteristics comprising:
computer readable program code means for causing a computer to identify, for each of the plurality of landmarks, a set of the vertices satisfying a criteria based on a surface difference between the vertex local surface characteristics and the landmark local surface characteristics;
and wherein the compatibility potential is based on a relational difference between the relational position of the pairs of neighboring landmarks and the relational position of each pair of vertices from the set of vertices corresponding to the pairs of neighboring landmarks;
and wherein the computer readable program code means for causing a computer to negotiate comprising:
computer readable program code means for causing a computer to determine one of the vertices for each of the plurality of landmarks that minimizes the surface difference and the relational difference for the landmark.

73. The article of manufacture according to claim 31 wherein the relational position is a 3-dimensional translation.

74. The article of manufacture according to claim 31 wherein the computer readable program code means for causing a computer to negotiate comprising:
computer readable program code means for causing a computer to perform probabilistic inferencing to maximize the surface potential for each of the compatibility potential for each of the plurality of landmarks.
